(19) United States
(12) Patent Application Publication
(10) Pub. No.: US 2008/0053490 A1
(43) Pub. Date: Mar. 6, 2008

(54) Method for hydrating a contact lens

(75) Inventors: Stuart Clark, South Lanarkshire (GB); Scott Wilson, Glasgow (GB)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/515,075

(22) Filed: Sep. 1, 2006

(51) Int. Cl. B08B 3/00; B08B 3/12

(52) U.S. Cl. 134/34; 134/198

(57) ABSTRACT

The method involves filling a well containing a contact lens with aqueous solution. Multiple injection nozzles inject streams of the aqueous solution into the well. The multiple injection nozzles are arranged to prevent non-centering of the contact lens in the well.

### BACKGROUND

In the manufacture of soft, hydrogel contact lenses, the lenses are typically hydrated and packaged in an aqueous solution. The lenses may also be extracted in an aqueous solution to remove undesired, residual material remaining from polymerization of the monomer mixture used to cast the contact lens. Extraction may be performed prior to, or concurrent with, hydration.

As seen in FIG. 1A, blister package 1 includes a well 2 surrounded by flange 3. Well 2 is designed to hold a contact lens 5 and aqueous packaging solution 7 therein, and flange 3 serves as a surface for sealing lidstock to the package. The packaging solution is added to the well 2 by an injection nozzle 8, which directs a stream 9 of the packaging solution on to contact lens 5, thus filling well 2 until the solution reaches fill line 10. Typically, the amount of packaging solution is a metered dose. Conventionally, the well 2 of blister package 1 is aligned centrally with nozzle 8, as seen in FIG. 1A.

FIG. 1B illustrates a problem that may arise in using the apparatus shown in FIG. 1A. In FIG. 1B, contact lens 5 is not centered in well 2. As stream 9 of package solution is injected on to contact lens 5 from nozzle 8, the pressure of the stream may actually maintain contact lens 5 is the non-centered position. Accordingly, portion 12 of contact lens remains above fill line 10.

### SUMMARY OF THE INVENTION

This invention provides a method that solves the aforementioned problems, resulting in improved yields, a higher quality product, and a more efficient manufacturing process.

The method of this invention comprises filling a well with aqueous solution, the well containing a contact lens, and wherein multiple injection nozzles inject streams of the aqueous solution into the well. According to preferred embodiments, there are at least three injection nozzles that inject streams of the aqueous solution, preferably arranged in a circular array.

The injection nozzles are preferably arranged such that at least one of the streams will inject aqueous solution on to the contact lens, serving to center the contact lens in the well.

The well may be part of a contact lens blister package, further comprising a flange surrounding the well. Lidstock may be sealed against the flange, after filling the well of the blister package with the aqueous solution. When used as the final solution for packaging the contact lens in the blister package, the solution is preferably buffered saline solution. Packages sealed with lidstock may be sterilized, for example, by autoclaving the blister package and its contents.

The method also includes evacuating the aqueous solution from the well, and refilling the well with additional aqueous solution. Multiple cycles of filling and evacuating may be used to extract residual materials from the contact lens.

The invention also provides an assembly comprising: a holder comprising a well that contains a contact lens; and a nozzle assembly postionable in alignment with the well, wherein the nozzle assembly includes multiple injection nozzles for directing streams of aqueous solution into the well. The holder may have the form of a well of a blister package.

### BRIEF DESCRIPTION OF THE DRAWING FIGURES

FIG. 1A is a cross-sectional view of a conventional apparatus for filling a contact lens blister package with solution.

FIG. 1B is a cross-sectional view of the apparatus of FIG. 1A where the contact lens is not centered.

FIG. 2 is a cross-sectional view of an apparatus and method according to various preferred embodiments of this invention.

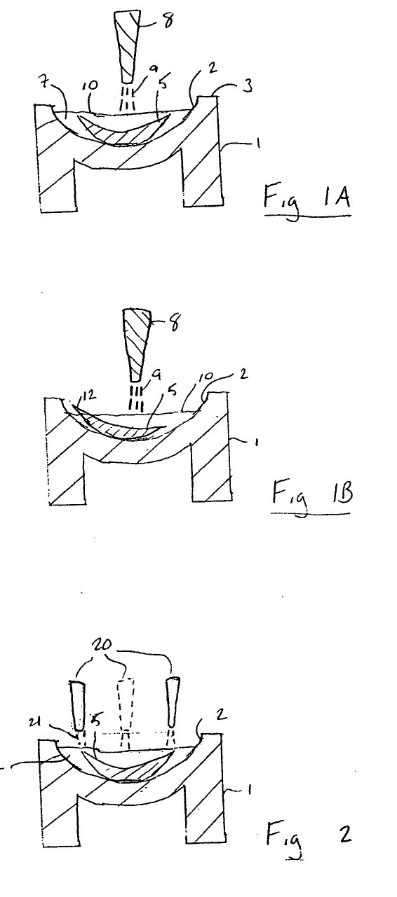

### DETAILED DESCRIPTION OF VARIOUS PREFERRED EMBODIMENTS

The majority of contact lenses sold today are made of soft hydrogel materials. Hydrogels are a cross-linked polymeric system that absorbs and retains water, typically 10 to 80 percent by weight, and especially 20 to 70 percent water. Hydrogel lenses are commonly prepared by polymerizing a lens-forming monomer mixture including at least one hydrophilic monomer, such as 2-hydroxyethyl methacrylate, N,N-dimethylacrylamide, N-vinyl-2-pyrrolidone, glycerol methacrylate, and methacrylic acid. In the case of silicone hydrogel lenses, a silicone-containing monomer is copolymerized with the hydrophilic monomers.

Various processes are known for manufacturing contact lenses. One process, referred to as static cast molding, involves casting a mixture of lens-forming monomers in a two-part mold. One mold part includes a molding surface for forming the front lens surface, and the second mold part includes a molding surface for forming the back lens surface. The monomer mixture is polymerized, or cured, while in the two-part mold to form a contact lens. After casting and polymerization, the lens is separated from the mold.

Following casting of the contact lens, the cast lens is subjected to various downstream processes. In the case of non-silicone hydrogel contact lenses, the lenses are typically extracted with water or an aqueous solution to remove any impurities and to hydrate the lens. Such extraction and hydration processes may be formed as a combined, single operation or as multiple, separate operations. Then, the lens is typically inspected, either manually or with automation, and packaged for sale in a sealed package. In the case of silicone hydrogel contact lenses, the lenses generally require a more rigorous extraction process, employing an organic solvent to remove impurities such as unreacted monomers or oligomers formed as byproducts of the polymerization process. Then, the lenses are subjected to one or more hydration steps where the lens are contacted with water or an aqueous solution, so as to hydrate the lens and replace the organic solvent used in the prior extraction step.

FIG. 2 illustrates an assembly according to various preferred embodiments. This assembly may be used to extract a soft hydrogel contact lens with an aqueous solution and/or to hydrate such a contact lens in an aqueous packaging solution.

Blister package 1 includes well 2 which contains a soft contact lens 5. Multiple injection nozzles 20, three in the illustrated embodiment, are arranged in a circular array. In other words, the well 2 is positioned beneath the injection nozzles 20, such that this circular array of nozzles surrounds the center of well 2.

Each nozzle 20 injects a stream 21 of aqueous solution 7 into the well. The amount of solution injected by nozzles 20 may be metered so that a predetermined amount of aqueous solution is dosed into well 2. Even if contact lens 5 is initially not centered in well 2, the array of streams from the injection nozzles will serve to center the contact lens, or, at least position the contact lens more to the center and away from the sides of the well, as the well is filled with the aqueous solution.

FIG. 2 illustrates the contact lens contained in the well of a blister package. The solution introduced by the nozzles may be a packaging solution, such as buffered saline solution. In such a case, after filling the well, the packages may be sealed with lidstock and sterilized, for example, by autoclaving the blister package and its contents. Lidstock may be sealed against the flange surrounding well 2.

The assembly shown in FIG. 2 may also be used for extracting a contact lens contained in the well with an aqueous solution other than the final packaging solution. For example, distilled water or other aqueous solution may be added to well, and then this solution may be evacuated. Multiple cycles of filling and evacuating may be used to extract residual materials from the contact lens.

Although FIG. 2 illustrates the contact lens contained in the well of a blister package, the well may be formed in other types of lens carriers or holders, such as a tray.

Although various preferred embodiments have been illustrated, many other modifications and variations of the present invention are possible to the skilled practitioner. It is therefore understood that, within the scope of the claims, the present invention can be practiced other than as herein specifically described.

We claim:

1. A method comprising filling a well with aqueous solution, the well containing a: contact lens, and wherein multiple injection nozzles inject streams of the aqueous solution into the well.

2. The method according to claim 1, wherein at least three injection nozzles inject streams of the aqueous solution.

3. The method according to claim 2, wherein the injection nozzles are arranged in a circular array.

4. The method according to claim 1, wherein the injection nozzles are arranged such that at least one of the streams will inject aqueous solution on to the contact lens.

5. The method according to claim 4, wherein injection of the streams of the aqueous solution center the contact lens in the well.

6. The method according to claim 1, wherein the well is included in a blister package.

7. The method according to claim 1, further comprising sealing lidstock on to a flange of the blister package after filling the well of the blister package with the aqueous solution.

8. The method according to claim 7, further comprising autoclaving the blister package and its contents after sealing the lidstock to the flange.

9. The method according to claim 1, further comprising evacuating the aqueous solution from the well, and refilling the well with additional aqueous solution.

10. The method according to claim 1, wherein the aqueous solution comprises buffered saline solution, and the well is included in a blister package.

11. An assembly comprising: holder comprising a well that contains a contact lens; and a nozzle assembly postionable in alignment with the well, wherein the nozzle assembly includes multiple injection nozzles for directing streams of aqueous solution into the well.

12. The assembly according to claim 11, wherein the holder is a blister package including the well and a flange surrounding the well.

13. The assembly according to claim 11, wherein the nozzle assembly includes at least three injection nozzles.

14. The assembly according to claim 11, wherein the injection nozzles are arranged in a circular array.

15. The assembly according to claim 1, wherein the injection nozzles are arranged such that when the holder is positioned in alignment with the well, at least one of the streams will inject aqueous solution on to the contact lens.
